(19) United States
(12) Patent Application Publication
(10) Pub. No.: US 2021/0209776 A1
(43) Pub. Date: Jul. 8, 2021

(54) METHOD AND DEVICE FOR DEPTH IMAGE FUSION AND COMPUTER-READABLE STORAGE MEDIUM

(71) Applicant: SZ DJI TECHNOLOGY CO., LTD., Shenzhen (CN)

(72) Inventors: Sheng HUANG, Shenzhen (CN); Jiabin LIANG, Shenzhen (CN)

(21) Appl. No.: 17/211,054

(22) Filed: Mar. 24, 2021

Related U.S. Application Data
(63) Continuation of application No. PCT/CN2018/107751, filed on Sep. 26, 2018.

(51) Int. Cl. G06T 7/33; G06T 7/73; G06T 7/55; G06T 7/90; G06T 5/50

(52) U.S. Cl. CPC G06T 7/337; G06T 7/74; G06T 7/55; G06T 2207/30244; G06T 5/50; G06T 2207/20221; G06T 2207/10028; G06T 7/90

(57) ABSTRACT

The present disclosure includes a depth image fusion method. The method includes obtaining one depth image and a reference pixel positioned in one of the depth images; determining a candidate queue corresponding to the reference pixel, the candidate queue storing one pixel to be fused that has not been fused in the depth image; determining a fusion queue corresponding to the reference pixel in the one of the depth images in the candidate queue, and pressing pixel to be fused in the candidate queue to the fusion queue, the fusion queue storing one selected fusion pixel in the depth image; obtaining feature information of the selected fusion pixel in the fusion queue; determining standard feature information of the fused pixel; and generating a fused point cloud corresponding to one of the depth images based on the standard feature information of the fused pixel.

### CROSS-REFERENCE TO RELATED APPLICATION

This application is a continuation of International Application No. PCT/CN2018/107751, filed on Sep. 26, 2018, the entire content of which is incorporated herein by reference.

### TECHNICAL FIELD

The present disclosure relates to the technical field of image processing technology and, more specifically, to a method and device for depth image fusion and a computer-readable storage medium.

### BACKGROUND

With the continuous development of three-dimensional (3D) reconstruction technology, there is more and more demand for 3D reconstruction. The conventional 3D reconstruction methods include large-scale 3D reconstruction using images with multi-view stereo vision technology, 3D construction using lidar to scan scenes, and 3D reconstruction using various structured optical scanning devices. One of the core products of all 3D reconstructions is the point cloud data. The point cloud data includes a plurality of discrete 3D coordinate points with color. These dense 3D points can be combined to describe the entire reconstructed scene.

During the reconstruction process, many parts of the scene will be observed or scanned multiple times. Every observation or scan will produce a lot of point clouds describing the part. During the entire reconstruction process, each part of the scene generally has a large number of redundant points, which makes the point cloud of the whole scene too large, which is not convenient for rending and displaying. In addition, the large number of point clouds generated are often accompanied by more noise.

### SUMMARY

One aspect of the present disclosure provides a depth image fusion method. The method includes obtaining at least one depth image and a reference pixel positioned in at least one of the depth images; determining a candidate queue corresponding to the reference pixel in at least one of the depth images, the candidate queue storing at least one pixel to be fused that has not been fused in the depth image; determining a fusion queue corresponding to the reference pixel in the at least one of the depth images in the candidate queue, and pressing pixel to be fused in the candidate queue to the fusion queue, the fusion queue storing at least one selected fusion pixel in the depth image; obtaining feature information of the selected fusion pixel in the fusion queue; determining standard feature information of the fused pixel based on the feature information of the selected fusion pixel; and generating a fused point cloud corresponding to at least one of the depth images based on the standard feature information of the fused pixel.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a depth image fusion method according to an embodiment of the present disclosure.

FIG. 2 is a flowchart of determining a candidate queue corresponding to a reference pixel in at least one of the depth images according to an embodiment of the present disclosure.

FIG. 3 a flowchart of another depth image fusion method according to an embodiment of the present disclosure.

FIG. 4 a flowchart of another depth image fusion method according to an embodiment of the present disclosure.

FIG. 5 a flowchart of another depth image fusion method according to an embodiment of the present disclosure.

FIG. 6 a flowchart of another depth image fusion method according to an embodiment of the present disclosure.

FIG. 7 a flowchart of another depth image fusion method according to an embodiment of the present disclosure.

FIG. 8 a flowchart of the depth image fusion method according to an application embodiment of the present disclosure.

FIG. 9 is a schematic diagram of a relationship between a re-projection error and a normal vector angle according to an application embodiment of the present disclosure.

FIG. 10 is a schematic structural diagram of a depth image fusion device according to an embodiment of the present disclosure.

FIG. 11 is a schematic structural diagram of another depth image fusion device according to an embodiment of the present disclosure.

### DETAILED DESCRIPTION OF THE EMBODIMENTS

In order to make the objectives, technical solutions, and advantages of the present disclosure more clear, the technical solutions in the embodiments of the present disclosure will be described below with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Unless otherwise defined, all the technical and scientific terms used in the present disclosure have the same or similar meanings as generally understood by one of ordinary skill in the art. As described in the present disclosure, the terms used in the specification of the present disclosure are intended to describe example embodiments, instead of limiting the present disclosure.

In the embodiments of the present disclosure, “at least one” means one or more, and “a plurality of” means two or more. The term “and/or” used herein describes only an association relationship for describing associated objects and represents that three relationships may exist. For example, A and/or B may represent the following three cases: Only A exists, both A and B exist, and only B exists, where A and B can be singular or plural. The character “/” in this specification generally indicates that association objects are an “or” relationship, but may also indicate an “and/or” relationship. “At least one of the following items” or a similar expression means any combination of these items, including any combination of a single item or a plurality of items. For example, at least one of a, b, and c may represent a, b, c, a-b, a-c, b-c, or a-b-c, where a, b, and c may be a single one or a plurality of.

Exemplary embodiments will be described with reference to the accompanying drawings. In the case where there is no conflict between the exemplary embodiments, the features of the following embodiments and examples may be combined with each other.

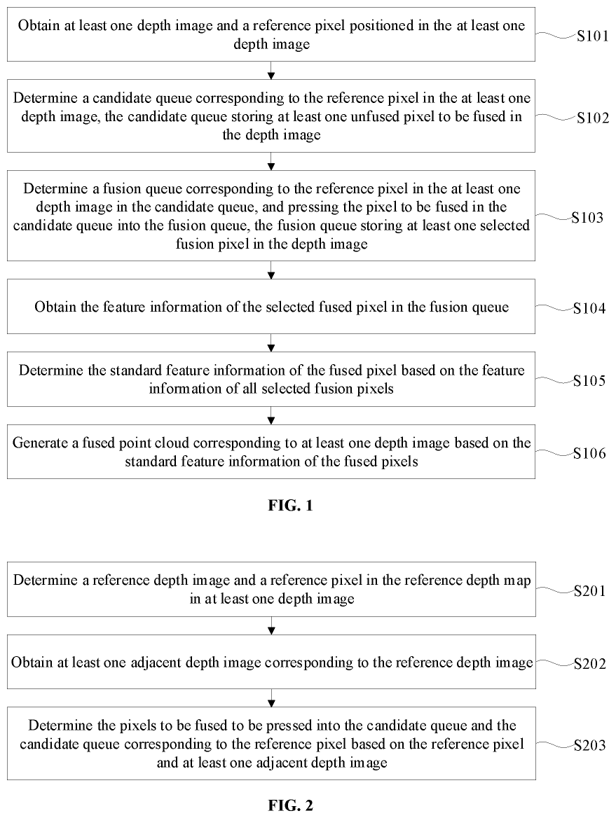

FIG. 1 is a flowchart of a depth image fusion method according to an embodiment of the present disclosure. Referring to FIG. 1, an embodiment of the present disclosure provides a depth image fusion method to reduce redundant point clouds, while maintaining various details in the scene to ensure the display quality and efficiency of the depth image. The method will be described in detail below.

S101, obtaining at least one depth image and a reference pixel positioned in the at least one depth image.

In some embodiments, the depth image may be obtained by the multi-view stereo vision method, or the depth image may also be obtained by a structured light acquisition device (e.g., Microsoft Kinect). Of course, those skilled in the art may also use other methods to obtain the depth image, which will not be repeated here. In addition, the reference pixel may be any pixel in the depth image. The reference pixel may be a pixel selected by the user or a randomly determined pixel. The selection of the reference pixel can be set based on the needs of the user, which will not be repeated here.

S102, determining a candidate queue corresponding to the reference pixel in the at least one depth image, the candidate queue storing at least one unfused pixel to be fused in the depth image.

S103, determining a fusion queue corresponding to the reference pixel in the at least one depth image in the candidate queue, and pressing the pixel to be fused in the candidate queue into the fusion queue, the fusion queue storing at least one selected fusion pixel in the depth image.

Since the fusion of depth images is a process of fusing pixel by pixel in the depth images. Therefore, to facilitate the fusion of depth image, each reference pixel in the at least one depth image can correspond to a candidate queue and a fusion queue. The candidate queue can store the pixels to be fused that are not fused in the depth image, and the fusion queue can stored the selected fused pixels in the depth image. When the unfused pixel to be fused in the depth image meets a fusion condition, the pixel to be fused will be filtered out from the candidate queue and pressed into the fusion queue.

In addition, when the pixels to be fused that meet the fusion condition are pressed into the fusion queue, the pixels to be fused at this time may not be subjected to the corresponding fusion operation. Instead, after all pixels to be fused in the candidate queue meet the fusion condition and are pressed into the fusion queue, the corresponding fusion operation can be performed. That is, when the candidate queue is empty, the fusion calculation of the selected fusion pixels in the fusion queue can start to generate the fused point cloud. It should be noted that the foregoing candidate queue being empty may indicate that the candidate queue corresponding to the reference pixel in the at least one depth image is empty, or certain candidate queues corresponding to certain reference pixels positioned in the at least one depth image are empty, or all candidate queues corresponding to all reference pixels positioned in the at least one depth image are empty. The selection of the candidate queue can be set based on user's design requirement, and will not be described here.

S104, obtaining the feature information of the selected fused pixel in the fusion queue.

For ease of understanding, the following description takes the candidate queue and the fusion queue corresponding to a certain reference pixel as an example. In the process of fusing the depth image, whether the depth image is fused can be determined by detecting whether all pixels to be fused in the candidate queue are pressed into the fusion queue. In some embodiments, the pressing operation here may be similar to the press operation of pressing pixels onto a stack in the field of image processing. When all the pixels to be fused in the candidate queue have been pressed into the fusion queue, the feature information of all selected fusion pixels in the fusion queue can be obtained. In some embodiments, the feature information may include coordinate information. At this time, fusion calculation can be performed on the positions of all selected fusion pixels in the fusion queue. Alternatively, the feature information may include coordinate information and color information. At this time, fusion calculation can be performed on the positions and colors of all selected fusion pixels in the fusion queue. Of course, those skilled in the art can also set the specific content of the feature information based on specific design requirements.

S105, determining the standard feature information of the fused pixel based on the feature information of all selected fusion pixels.

When the feature information includes coordinate information, the coordinate information of all selected fusion pixels can be obtained first, and the standard coordinate information of the fused pixels can be determined based on the coordinate information of all selected fusion pixels. In some embodiments, the standard coordinate information can be the median value of the coordinate information of all selected fusion pixels. For example, the 3D coordinate information of all selected fusion pixels may include (x1, y1, z1), (x2, y2, z2), and (x3, y3, z3). The x-coordinates, y-coordinates, and z-coordinates in the above 3D coordinate information may be sorted respectively to obtain the relationship x1<x3<x2, y2<y1<y3, and z3<z2<z1. From the above sorting, it can be seen that for the x-coordinate dimension, x3 is the median value, for the y-coordinate dimension, y1 is the median value, and for the z-coordinate dimension, z2 is the median value. Therefore, (x3, y1, z2) can be determined as the standard coordinate information of the fused pixel. Of course, those skilled in the art can also use other methods to determine the standard coordinate information of the fused pixel based on the coordinate information of all selected fusion pixels. For example, the average value of the coordinate information of all selected fusion pixels can be determined as the standard coordinate information of the fused pixels, etc.

When the feature information includes the coordinate information and the color information, determining the standard feature information of the fused pixels based on the feature information of all selected fusion pixels ma include the following process.

S1051, determining the median value in the coordinate information of all selected fusion pixels as the standard coordinate information of the fused pixels.

The specific implementation process of the above process may be similar to the specific implementation process of the feature information including the coordinate information. For detail, reference may be made to the previous description, which will not be repeated here.

S1052, determining the median value in the color information of all selected fusion pixels as the standard color information of the fused pixels.

For example, the color information of all selected fusion pixels may include (r1, g1, b1), (r2, g2, b2), and (r3, g3, b3). The red signal r, green signal g, and blue signal b in the above color information may be sorted respectively to obtain the relationship r1<r2<r3, g2<g1<g3, and b3<b2<b1. Form the above sorting, it can be seen that for the r dimension of the red signal, r2 is the median value, for the g dimension of the green signal, g1 is the median value, and for the b dimension of the blue signal, b2 is the median value. Therefore, (r2, g1, b2) can be determined as the standard color information of the fused pixel. Of course, those skilled in the art can also use other methods to determine the standard color information of the fused pixel. For example, the average value of the color information of all selected fusion pixels can be determined as the standard color information of the pixels after fusion, etc.

S106, generating a fused point cloud corresponding to at least one depth image based on the standard feature information of the fused pixels.

After obtaining the standard feature information of the fused pixels, the fused point cloud data corresponding to at least one depth image can be generated based on the standard feature information, thereby realizing the fusion process of the depth images.

The depth image fusion method provided in this embodiment can realize the pixel by pixel fusion in the depth image by obtaining the feature information of all pixels selected for fusion in the fusion queue. Further, the standard feature information of the fused pixels can be determined based on the feature information of all selection fusion pixels, such that the fused point cloud corresponding to the at least one depth image can be generated based on the standard feature information of the fused pixels. The fused pixels can be used to replace all the selected fusion pixels to generate the point cloud data, which can effectively reduce redundant point cloud data, while maintaining various details in the scene, which further ensures the efficiency of synthesizing point cloud data from the depth image and display quality of the synthesized point cloud data, thereby improving the practicability of the depth image fusion method, which is beneficial to the promotion and application of the related products.

FIG. 2 is a flowchart of determining a candidate queue corresponding to a reference pixel in at least one of the depth images according to an embodiment of the present disclosure. Referring to FIG. 2, it can be seen that the determination of the candidate queue corresponding to a reference pixel in the at least one depth image in this embodiment can include the following processes.

S201, determining a reference depth image and a reference pixel in the reference depth map in at least one depth image.

In some embodiments, the reference depth image may be any one of the at least one depth image. More specifically, the reference depth image may be a depth image selected by the user, or may also be a randomly determined depth image. Similar, the reference pixel may be any pixel in the reference depth image, and the reference pixel may be a pixel selected by the user, or may also be a randomly determined pixel.

S202, obtaining at least one adjacent depth image corresponding to the reference depth image.

After the reference depth image is determined, the degree of correlation between the reference depth image and other depth images (such as depth images with common coverage, etc.) may be analyzed and processed, thereby obtaining at least one adjacent depth image corresponding to the reference depth image. For example, when the degree of correlation between the reference depth image and a depth image is greater than or equal to a predetermined correlation threshold, the reference depth image and the depth image can be determined to be adjacent to each other. At this time, the depth image described above is the adjacent depth image corresponding to the reference depth image. It can be understood that there may be one or more adjacent depth images corresponding to the reference depth image.

S023, determining the pixels to be fused to be pressed into the candidate queue and the candidate queue corresponding to the reference pixel based on the reference pixel and at least one adjacent depth image.

After obtaining the reference pixel, the mapping relationship between the reference pixel and the candidate queue can be used to determine the candidate queue corresponding to the reference pixel. Alternatively, the position information of the reference pixel in the reference depth image where the reference pixel is positioned can also be obtained, and the candidate queue corresponding to the reference pixel can be determined based on the position information. Of course, those skilled in the art can also use other methods to determine the candidate queue, as long as the stability and reliability of the candidate queue corresponding to the reference pixel can be ensured, which will not be described here.

In addition, when determining the pixels to be fused to be pressed into the candidate queue, in this embodiment, the determination of the pixels to be fused to be pressed into the candidate queue based on the reference pixel and at least one adjacent depth image may include the following processes.

S2031, projecting the reference pixel to at least one adjacent depth image to obtain at least one first projection pixel.

In some embodiments, projecting the reference pixel on to at least one adjacent depth image may include the following processes.

S20311, calculating the reference 3D point corresponding to the reference pixel.

More specifically, the depth image where the reference pixel is positioned can be determined as the reference depth image, and the camera attitude information in the world coordinate system corresponding to the reference depth image can be obtained. In some embodiments, the camera attitude information in the world coordinate system may include coordinate information, rotation angle, etc. After the camera attitude information is obtained, the camera attitude information can be analyzed and processed, and the reference 3D point of the reference pixel in the world coordinate system can be determined based on the analyzed camera attitude information.

S20312. Projecting the reference 3D point onto at least one adjacent depth image to obtain at least one projection pixel.

S2032, detecting adjacent pixels in at least one adjacent depth image based on the at least one first projection pixel.

After obtaining the first projection pixel, the first projection pixel can be analyzed and processed to detect the adjacent pixels in at least one adjacent depth image.

S20321, obtaining the unfused pixels in at least adjacent depth image based on at least one first projection pixel.

S20322, determining adjacent pixels in at least one adjacent depth image based on the unfused pixels in at least one adjacent depth image.

More specifically, determining the adjacent pixels in at least one adjacent depth image based on the unfused pixels in the at least one adjacent depth image may include the following processes.

S203221, obtaining the traversal levels corresponding to the unfused pixels in the at least one adjacent depth image.

In some embodiments, the traversal level of each pixel may refer to the number of depth images that are fused with that pixel. For example, when the traversal level corresponding to an unfused pixel is three, it may indicate that the pixel is fused with three depth images.

S203222, determining the unfused pixels whose traversal level is less than a predetermined traversal level as the adjacent pixels.

In some embodiments, the predetermined traversal level may be a predetermined traversal level threshold. The predetermined traversal level may indicate the maximum number of depth images that each pixel can be fused with. When the predetermined traversal level is larger, the fusion granularity of the point cloud may be larger, and the number of points remaining in the depth image may be smaller.

S2033, determining the first projection pixel and the adjacent pixels as the pixels to be fused and pressed into the candidate queue.

After determining the first projection pixel and the adjacent pixels, the first projection pixel and the adjacent pixels can be determined as the pixels to be fused, then the pixels determined to be fused can be pressed into the candidate queue.

After determining the first projection pixel and the adjacent pixels as the pixels to be fused, and pressing them into the candidate queue, in order to accurately obtain the traversal level of each pixel, the method may further include the following process.

S301, adding one to the traversal level of pixels pressed into the candidate queue.

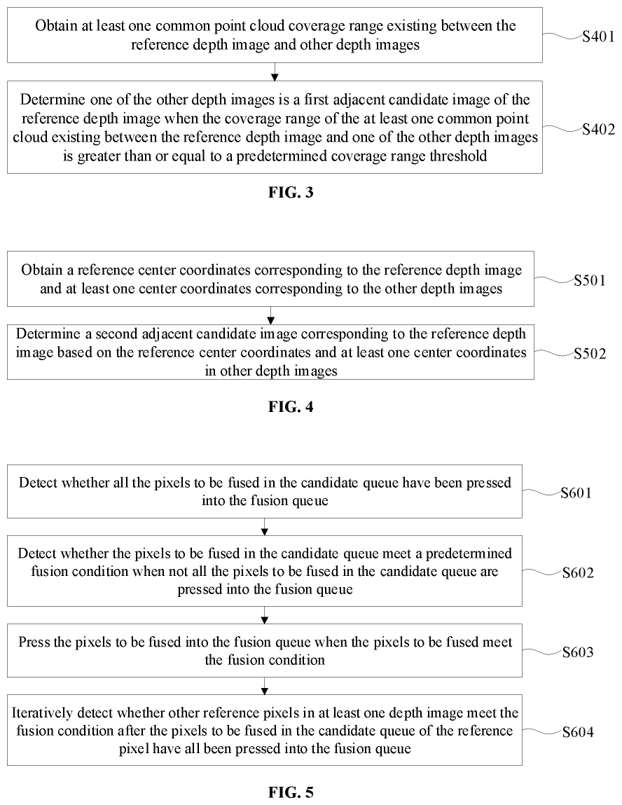

FIG. 3 a flowchart of another depth image fusion method according to an embodiment of the present disclosure. Based on the above embodiment and referring to FIG. 3, before obtaining at least one adjacent depth image corresponding to the reference depth image, the method in this embodiment further includes the following processes.

S401, obtaining at least one common point cloud coverage range existing between the reference depth image and the other depth images.

In some embodiments, the other depth images in the process at S401 may be part of at least one depth image in the above embodiment. More specifically, the at least one depth image in the processes described in the above embodiment may include a reference depth image and other depth images. That is, the other depth images in the process at S401 may include all depth images except the reference depth image in the at least one depth image.

In addition, when obtaining the at least one common point cloud coverage range, the point cloud distribution range of the reference depth image and the point distribution range of other depth images can be calculated, and the common point cloud coverage range of the reference depth image and the other images can be determined based on the point cloud distribution range of the reference depth image and the point cloud distribution range of the other depth images. The point cloud data in the common point cloud coverage range may be positioned both in the reference depth image and in other depth images corresponding to the common point cloud coverage. Further, one or more common point cloud coverage ranges may exist between any one of the reference depth image and the other depth images. Of course, those skilled in the art can also use other methods to obtain at least one common point cloud coverage range between the reference depth image and other depth images, as long as the stability and reliability of the determination of the common point cloud coverage range can be ensured, which will not be described here.

S402, determining one of the other depth images is a first adjacent candidate image of the reference depth image when the coverage range of the at least one common point cloud existing between the reference depth image and one of the other depth images is greater than or equal to a predetermined coverage range threshold.

After obtaining the at least one common point cloud coverage range between the reference depth image and a depth image, the common point cloud coverage range can be compared with the predetermined coverage range threshold. When the coverage range of the at least one common point cloud is greater than or equal to the predetermined coverage range threshold, one of the other depth images may be determined as the first adjacent candidate image of the reference depth image. The first adjacent candidate image may be used to determine the adjacent depth image corresponding to the reference depth image. It should be noted that the number of the first adjacent candidate image may be one or more.

Further, after determining the first adjacent candidate image, obtaining at least one adjacent depth image corresponding to the reference depth image may include the following processes.

S2021, determining a first target adjacent candidate image in the first adjacent candidate image, the common point cloud coverage range between the first target adjacent candidate image and the reference depth image may be greater than or equal to the predetermined coverage range threshold.

After the first adjacent candidate image is obtained, the common point cloud coverage range between the first candidate image and the reference depth image can be obtained. After the common point cloud coverage range is obtained, the common point cloud coverage range can be analyzed and compared with the predetermined coverage range threshold. When the common point cloud coverage range between the first adjacent candidate image and the reference depth image is greater than or equal to the predetermined coverage range threshold, the first adjacent candidate image can be determined as the first target adjacent candidate image. By using the above method, at least one first target adjacent candidate image can be determined in the first adjacent candidate image.

S2022, sorting the first target adjacent candidate images based on the size of the common point cloud coverage range with the reference depth image.

More specifically, the size of the common point cloud coverage range can be sorted in a descending order. For example, there may be three first target adjacent candidate images P1, P2, and P3, and the common point cloud coverage range between the three first target adjacent candidate images and the reference depth image may be F1, F2, and F3. The order of F1, F2, and F3 may be F1<F3<F2. At this time, the size of the common point cloud coverage can be sorted. That is, the first position may be the first target adjacent candidate image P2 corresponding to F2, the second position may be the first target adjacent candidate image P3 corresponding to F3, and the third position may be the first target adjacent candidate image P1 corresponding to F1.

S2023, determining at least one adjacent depth image corresponding to the reference depth image in the sorted first target adjacent candidate images based on a predetermined maximum number of adjacent images.

In some embodiments, the maximum number of adjacent images may be predetermined, and the maximum number of adjacent images may be used to limit the number of adjacent depth images. For example, when there are three first target adjacent candidate images P1, P2, and P3, and the maximum number of adjacent images is two, then two or one first target adjacent candidate images with the highest ranking can be selected from the sorted three first target adjacent candidate images. The selected two or one first target adjacent candidate images can be determined as the adjacent depth images. At this time, the number of the adjacent depth images can be two or one.

In the embodiments of the present disclosure, by obtaining at least one common point cloud coverage range between the reference depth image and other depth images, the first adjacent candidate images can be determined by the common point cloud coverage range. Further at least one adjacent depth image corresponding to the reference depth image in the first adjacent candidate images can be determined. The implementation manner is simple, which can improve the efficiency of obtaining the adjacent depth images.

FIG. 4 a flowchart of another depth image fusion method according to an embodiment of the present disclosure. Referring to FIG. 4, before obtaining the at least one adjacent depth image corresponding to the reference depth image, the method in this embodiment may further include the following processes.

S501, obtaining a reference center coordinates corresponding to the reference depth image and at least one center coordinates corresponding to the other depth images.

In some embodiments, the reference center coordinates may be the image center coordinates, the camera center coordinates, or the target coordinates determined based on the image center coordinates and/or the camera center coordinates. Similarly, the center coordinates may also be the image center coordinates, the camera center coordinates, or the target coordinates determined based on the image center coordinates and/or the camera center coordinates. It should be noted that the camera center coordinates described above may be the coordinate information of the center of gravity or center point of the imaging device projected onto the depth image when the depth image is captured by the imaging device.

S502, determining a second adjacent candidate image corresponding to the reference depth image based on the reference center coordinates and at least one center coordinates in other depth images.

After obtaining the reference center coordinates and at least one center coordinates in other depth images, the reference center coordinates and the at least one center coordinates can be analyzed and processed to determine the second adjacent candidate image based on the analysis and processing results. The second adjacent candidate image may be used to determine the adjacent depth image corresponding to the reference depth image. More specifically, determining the second adjacent candidate image corresponding to the reference depth image based on the reference center coordinates and at least one center coordinates in other depth images may include the following processes.

S5021, obtaining at least one 3D pixel, the 3D pixel may be positioned in the common point cloud coverage range between the reference depth image and a depth image in other depth images.

More specifically, obtaining at least one 3D pixel may include the following processes.

S50211, obtaining the first camera attitude information in the world coordinate system corresponding to the reference depth image and the second camera attitude information in the world coordinate system corresponding to one of the other depth images.

More specifically, the first camera attitude information and the second camera attitude information in the world coordinate system may include coordinate information, a rotation angle, and the like in the world coordinate system.

S50212, determining at least one 3D pixel based on the first camera attitude information and the second camera attitude information in the world coordinate system.

After obtaining the first camera attitude information and the second camera attitude information in the world coordinate system, the first camera attitude information and the second camera attitude information in the world coordinate system can be analyzed and processed, thereby determining at least one 3D pixel in the world coordinate system within the common point cloud coverage range existing between the reference depth image and one of the other depth images.

S5022, determining a first ray based on the reference center coordinates and the 3D point.

In some embodiments, the reference center coordinates may be connected with the determined 3D point to determine the first ray.

S5023, determining at least one second ray based on at least one center coordinate and the 3D point.

In some embodiments, the center coordinate may be connected with the 3D point to determine the second ray. Since there is at least one center coordinate, therefore, the number of second rays obtained is also at least one.

S5024, obtaining at least one angle formed between the first ray and at least one second ray.

After obtaining the first ray and the second ray, the angle formed between the first ray and the second ray can be obtained. Since there is at least one second ray, the number of angles formed is also at least one.

S5025, determining the second adjacent candidate images corresponding to the reference depth image based on at least one angle.

More specifically, determining the second adjacent candidate images corresponding to the reference depth image based on at least one angle may include the following processes.

S50251, obtaining a target angle with the smallest angle in the at least one angle.

The at least one angle obtained can be sorted to obtain the target angle with the smallest angle in the at least one angle.

S50252, determining the depth image corresponding to the target angle as the second adjacent candidate image corresponding to the reference depth image when the target angle is greater than or equal to a predetermined angle threshold.

After determining the depth image corresponding to the target angle is the second adjacent candidate image corresponding to the reference depth image, the obtained second adjacent candidate image can be analyzed and processed to determine at least one adjacent depth image corresponding to the reference depth image. More specifically, obtaining at least one adjacent depth image corresponding to the reference depth image may include the following processes.

S2024, determining a plurality of second target adjacent candidate images in the first adjacent candidate images and the second adjacent candidate images. The common point cloud coverage range between the second target adjacent candidate images and the reference depth image may be greater than or equal to the predetermined coverage range threshold, and the target angle corresponding to the second target adjacent candidate images may be greater than or equal to the predetermined angle threshold.

S2025, sorting the second target adjacent candidate images based on the size of the common point cloud coverage range with the reference depth image.

S2026, determining at least one adj acent depth image corresponding to the reference depth image in the sorted second target adjacent candidate images based on a predetermined maximum number of adjacent images.

The specific implementation methods and implementation effects of the processes at S2025 and S2026 in this embodiment is similar to those of the processes at S2022 and S2023 in the foregoing embodiment. For details, reference may be made to the above description, which will not be repeated here.

In this embodiment, at least one adjacent depth image corresponding to the reference depth image can be determined through the first adjacent candidate images and the second adjacent candidate images, which can effectively ensure the accuracy of determining the adjacent depth image, and further improve the accuracy of the method.

FIG. 5 a flowchart of another depth image fusion method according to an embodiment of the present disclosure. As shown in FIG. 5, the method in this embodiment may include the following processes.

S601, detecting whether all the pixels to be fused in the candidate queue have been pressed into the fusion queue.

More specifically, whether there are still pixels to be fused in the candidate queue can be detected. If there is no pixel to be fused in the candidate queue, it may indicate that all the pixels to be fused in the candidate queue have been pressed into the fusion queue. If there are pixels to be fused in the candidate queue, it may indicate that the pixels to be fused in the candidate queue are not all pressed into the fusion queue.

S602, detecting whether the pixels to be fused in the candidate queue meet a predetermined fusion condition when not all the pixels to be fused in the candidate queue are pressed into the fusion queue.

In some embodiments, the pixels to be fused in the candidate queue can be compared with the predetermined fusion condition to determine whether the pixels to be fused can be fused with the reference pixels. Further, the predetermined fusion condition may be related to one or more of the depth value error, normal vector angle, re-projection error, or traversal level. When detecting whether the pixel to be fused in the candidate queue meet the predetermined fusion condition, it can be determined by the analysis and processing result of the one or more parameters of the pixel to be fused.

S603, pressing the pixels to be fused into the fusion queue when the pixels to be fused meet the fusion condition.

When the pixels to be fused in the candidate queue meet the predetermined fusion condition, the pixels to be fused that meet the predetermined fusion condition can be marked as the selected fusion pixels, and the selected fusion pixels can be pressed into the fusion queue to realize the fusion process of the reference pixel in the depth image and the selected fusion pixels. Further, in some embodiments, the reference pixel can be pressed into the fusion queue together, and fused with the selected fusion pixels in the fusion queue.

S064, iteratively detecting whether other reference pixels in at least one depth image meet the fusion condition after the pixels to be fused in the candidate queue of the reference pixel have all been pressed into the fusion queue.

It should be noted that since each reference pixel may correspond to a candidate queue and a fusion queue, for the candidate queue and the fusion queue corresponding to the reference pixel, the method may further include selecting the pixels to be fused that do not meet the fusion condition in the candidate queue and removing these pixels to be fused from the candidate queue when the candidate queue includes pixels to be fused that do not meet the fusion condition in the candidate queue to complete the detection process of the fusion state of the reference pixel, such that the fusion state of the next reference pixel can be detected and determined. Alternatively, after all the pixels to be fused in the candidate queue of the reference pixel have been pressed into the fusion queue, iterative detection processing can also be performed on other reference pixels in the at least one depth image to determine whether the other reference pixels meet the fusion condition until the detection of whether all reference pixels in the reference pixel meet the fusion condition is complete, thereby realizing the detection and determination of whether the depth image can be fused. In some embodiments, the implementation process of the iterative detection process for determining whether other reference pixels meet the fusion condition may be similar to the implementation process of the detection process for one reference pixel described above, which will not be repeated here.

Further, since the predetermined fusion condition can be related to one or more parameters of the depth value error, the normal vector angle, the re-projection error, or the traversal level. Therefore, before detecting whether the pixels to be fused in the candidate queue meet the predetermined fusion condition, the method may include the following processes.

S701, obtaining the depth value error between the pixels to be fused and the reference pixel in the reference depth image.

In some embodiments, the error between the z value (the depth value) of the 3D point corresponding to the pixel to be fused and the z value of the reference pixel may be the depth value error. More specifically, a first gray value corresponding to the depth pixel of the pixel to be fused and a second gray value corresponding to the depth pixel of the reference pixel can be obtained first. Subsequently, the difference between the first gray value and the second gray value can be determined as the depth value error.

S702, obtaining the angle between the normal vector of the pixel to be fused and the reference pixel in the reference depth image.

In some embodiments, the angle between the normal vector of the 3D point corresponding to the pixel to be fused and the normal vector of the reference pixel may be the normal vector angle.

S703, obtaining the re-projection error between a second projection pixel of the pixel to be fused and the reference pixel in the reference depth image.

In some embodiments, the distance difference between the pixel values of the 3D point corresponding to the pixel to be fused projected onto the camera plane where the reference pixel is position and the pixel value of the reference pixel may be the re-projection error.

S704, obtaining the traversal level of the pixels to be fused.

In addition, before obtaining the re-projection error between the second projection pixel of the pixels to be fused and the reference pixel in the reference depth image, the method may further include the following process.

S801, projecting the pixel to be fused onto the reference depth image to obtain the second projection pixel corresponding to the pixel to be fused.

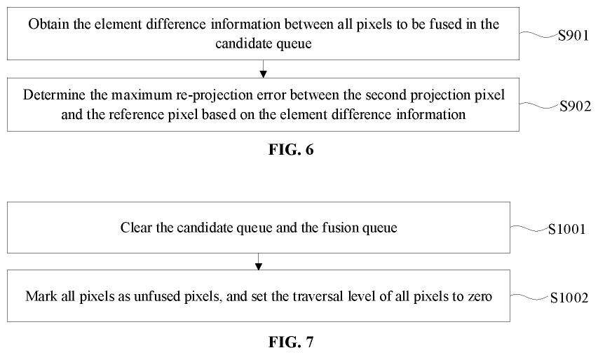

FIG. 6 a flowchart of another depth image fusion method according to an embodiment of the present disclosure. Referring to FIG. 6, after obtaining the re-projection error between the second projection pixel of the pixels to be fused and the reference pixel in the reference depth image, the method may further include the following processes.

S901, obtaining the element difference information between all pixels to be fused in the candidate queue.

In some embodiments, the element difference information may include one or more of the vector difference information, the normal vector difference information, the color difference information, the curvature difference information, or the texture difference information.

S902, determining the maximum re-projection error between the second projection pixel and the reference pixel based on the element difference information.

When the element difference information is the color difference information, the maximum re-projection error between the second projection pixel and the reference pixel may be determined based on the color difference information. More specifically, the difference information of the colors can be determined by calculating the color variance. In some embodiments, the smaller the color variance, the greater the fusion probability between the second projection pixel and the reference pixel, and the larger the corresponding maximum re-projection error can be to strength the fusion.

When the element difference information is the curvature difference information, the maximum re-projection error between the second projection pixel and the reference pixel may be determined based on the curvature difference information. More specifically, when the curvature difference information is less than a predetermined curvature difference threshold, for example, when the predetermined curvature difference threshold is zero, the area can be considered as a flat area. At this time, the maximum re-projection error can also be larger to strength the fusion.

When the element difference information is the texture difference information, the maximum re-projection error between the second projection pixel and the reference pixel may be determined based on the texture difference information. More specifically, when the texture difference information is less than a predetermined texture difference threshold, it may indicate a higher probability of the fusion between the second projection pixel and the reference pixel, correspondingly, the maximum re-projection error can also be larger to strength the fusion.

When the element difference information includes the difference information of the vector angle, determining the maximum re-projection error between the second projection pixel and the reference pixel may be determined based on the element difference information may include the following processes.

S9021, calculating the vector angle between all pixels to be fused in the candidate queue.

S9022, determining a maximum vector angle in all vector angles.

S9023, determining the maximum re-projection error as a predetermined first maximum re-projection error when the maximum vector angle is less than or equal to a predetermined maximum vector angle threshold; and/or

S9024, determining the maximum re-projection error as a predetermined second maximum re-projection error when the maximum vector angle is greater than the predetermined maximum vector angle threshold, where the second maximum re-projection error may be less than the first maximum re-projection error.

For example, the vector angles between all pixels to be fused in the candidate queue may be a1, a2, a3, and a4, respectively, and a maximum vector angle may be determined in all the vector angles as a3. After obtaining the maximum vector angle a3, the maximum vector angle a3 can be compared with the predetermined maximum vector angle threshold A. If a3<A, the maximum re-projection error may be determined to be a first maximum re-projection error M1; and, if a3>A, the maximum re-projection error may be determined to be a second maximum re-projection error M2, where M2<M1.

Further, after obtaining the depth value error, the normal vector angle, the re-projection error, and the traversal level, whether the pixels to be fused in the candidate queue meet the predetermined fusion condition can be detected by using the following processes.

S6021, determining whether the depth value error is less than or equal to the predetermined maximum depth threshold, whether the normal vector angle is less than or equal to the predetermined maximum angle threshold, whether the re-projection error is less than or equal to the maximum re-projection error, and whether the traversal level is less than or equal to the predetermined maximum traversal level.

It should be noted that the maximum re-projection error may be the first maximum re-projection error or the second maximum re-projection error determined above.

S6022, determining the pixels to be fused in the candidate queue meet the predetermined fusion condition when the depth value error is less than or equal to the predetermined maximum depth threshold, when the normal vector angle is less than or equal to the predetermined maximum angle threshold, when the re-projection error is less than or equal to the maximum re-projection error, and when the traversal level is less than or equal to the predetermined maximum traversal level.

When the above parameters meet the corresponding conditions, the pixels to be fused in the candidate queue can be determined as meeting the predetermined fusion condition. When the above parameters do not meet the corresponding conditions, the pixels to be fused in the candidate queue can be determined as not meeting the predetermined fusion condition. As such, the accuracy and reliability of determining whether the pixels to be fused in the candidate queue meet the predetermined fusion condition can be effectively ensured, and the accuracy of the method can be improved. Further, in one embodiment, for each reference pixel, a candidate queue and a fusion queue can be respectively set. After the calculation of the reference pixel in the selected at least one depth image is completed, the processes at S201 to S203 can be repeated until all pixels in all the depth images are fused, and all the fusion pixels can be output to form a new fused point cloud image. For example, the selected fusion pixels in the fusion queue of the reference pixel can be directly fused to obtain the fused point cloud of the reference pixel. Subsequently, the next reference pixel can be calculated and fused until all pixels in all depth images are calculated and fused, or after the selected fusion pixels in the fusion queue of all pixels in all depth images are determined, the fusion can be performed together. As such, the efficiency of synthesizing point cloud data from the depth image and the display quality of the synthesized point cloud data can be further ensured.

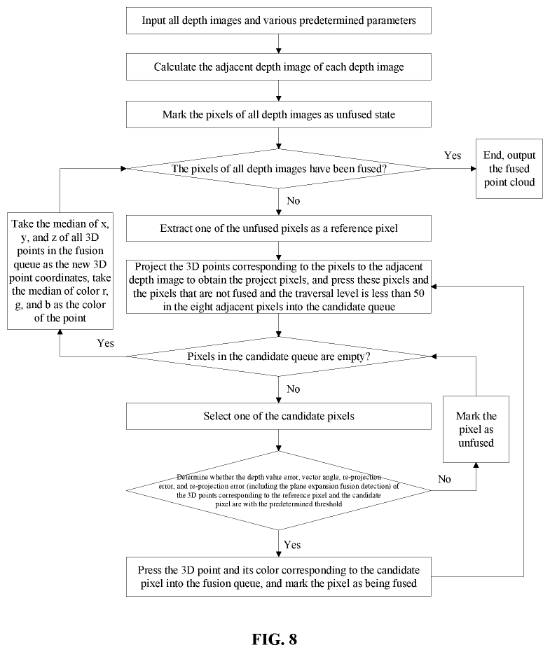

FIG. 7 a flowchart of another depth image fusion method according to an embodiment of the present disclosure. As shown in FIG. 7, before determining the candidate queue and the fusion queue corresponding to the at least one depth image, the method may further include the following processes.

S1001, clearing the candidate queue and the fusion queue.

S1002, marking all pixels as unfused pixels, and setting the traversal level of all pixels to zero.

When fusing the depth image, the depth image needs to be fused and analyzed based on the candidate queue and the fusion queue corresponding to the depth image. Therefore, before the depth image is fused, the candidate queue and the fusion queue can be clear, all pixels can be marked as unfused pixels, and the traversal level of all pixels can be set to zero to facilitate the fusion of pixels in the depth image based on the candidate queue and the fusion queue.

FIG. 8 a flowchart of the depth image fusion method according to an application embodiment of the present disclosure. As shown in FIG. 8, an embodiment of the present disclosure provides a depth image fusion method. In a specific application, the following parameters can be preset, where the maximum traversal level of each pixel can be set to max_traversal_depth, the maximum depth threshold of the 3D point can be set to max_depth_error, and the maximum angle threshold of the 3D point can be set to max_normal_error. The parameters of the plane extension fusion determination may include the maximum vector angle threshold max_normal_error_extend, the first maximum re-projection pixel error of the pixel corresponding to the 3D point max_reproj_error_extend, and the second maximum re-projection pixel error of the pixel corresponding to the 3D point max reproj error, where the first maximum re-projection pixel error max_reproj_error_extend may be greater than the second maximum re-projection pixel error of the pixel corresponding to the 3D point max_reproj_error.

More specifically, the depth image fusion method can include the following processes.

S1, obtaining all depth images prepared in advance.

S2, calculating the adjacent depth image of each depth image. Since the number of neighboring depth images corresponding to each depth image is limited, the maximum number of neighboring images for each depth image can be set to max_neighbor. Further the method for determining whether the two depth images are adjacent to each other may be as follow.

A, calculating the point cloud distribution range of each depth image, and calculating the common point cloud coverage range of the two depth images. If the common point cloud coverage range exceeds the coverage threshold region_threshold, the two depth images can be considered as adjacent candidate images of adjacent depth image

B, calculating the reference center coordinates corresponding to each depth image, connecting the reference center point to a 3D point in the common coverage area, and calculating the angle between the two rays. The two reference center coordinates and the angle between the two rays covering the 3D points can be repeatedly calculated. The smallest of all these angles can be taken as the target angle corresponding to the two depth images. If the target angle is greater than the angle threshold angle_threshold, then the two depth images can be considered as adjacent candidate images of adjacent depth images.

C, for each depth image, identifying all the depth images whose common coverage range is greater than region_threshold and the corresponding target angle is greater than angle_threshold, sorting these adjacent depth images in descending order of the common coverage range, and taking the previous max_neighbor image (if any) as the adjacent depth image of the depth image.

S3, marking all pixels of all depth images as unfused state, the traversal depth of all pixels as zero, and clearing the candidate queue and the fusion queue corresponding to the depth image.

S4, for each pixel that has not been fused, setting it as the current reference pixel and performing the following operations.

A, calculating the coordinates of the 3D point corresponding to the reference pixel, using the point as the reference pixel, and pressing the reference pixel into the fusion queue. The depth image where the pixel is positioned can be determined as the reference depth image.

B, identifying all adjacent depth images of the reference depth image, projecting the current reference pixel to all adjacent depth images, obtaining the pixels projected on each adjacent depth image, pressing these pixels and all the pixels in the surrounding eight neighborhoods that are not fused and whose traversal level is less than max_traversal_depth into the candidate queue, and adding one to the traversal level of all the pixels that are pressed into the candidate queue.

C, extracting an unfused pixel to be fused from the candidate queue, and determining the following information of the 3D point corresponding to the pixel to be fused.

(I), whether the depth value error between the 3D point and the reference pixel is within the predetermined max_depth_error.

(II), whether the angle between the normal vector of the 3D point and the normal vector of the reference pixel is within the predetermined max_normal_error.

(III), whether the traversal level of the 3D point is less than or equal to the max_traversal_depth.

(IV), projecting the 3D point onto the reference depth image, calculating the error between the projected pixel and the current reference pixel, and performing the plane expansion fusion detection.

In some embodiments, when performing the plane expansion fusion detection, whether the maximum vector angle between the pixels to be fused in the fusion queue is within max_normal_error_extend may be determined by using the following processes.

(1) Calculate the vector angle between all 3D points in the fusion queue.

(2) If the maximum angle described above is within max_normal_error_extend, the maximum re-projection pixel error may be set to max reproj error extend. Otherwise, the maximum re-projection pixel error may be set to max reproj error.

(3) Detect whether the error between the projected pixel and the current reference pixel is less than the maximum re-projection error.

Of course, for the plane expansion fusion detection method, in addition to the above method of detecting whether the maximum vector angle between the points in the fusion queue is within the max_normal_error_extend, all the plane areas in the scene can also be identified by performing image processing on the color map corresponding to the depth image (such as via machine learning, semantic segmentation, etc.). Subsequently, all the 3D point re-projection errors distributed in these plane areas can be directly set to max_reproj_error_extend. The following is a mathematical description of the expanded plane detection.

Assume that there are n types of elements that can affect the determination of the plane consistency, such as the normal vector angle, the curvature, the color (texture) consistency, the semantic consistency, etc. of the point cloud in the area to be determined. These i elements be denoted as pᵢ, and the difference of elements pᵢ can be denoted as σₚ_{ᵢ}². Then the following formula can be used to set the size of the re-projection pixel error:

$${\sum }_{i = 0}^{n} \frac{{σ}_{{p}_{i}}^{2}}{{max\_p}_{i}^{2}} + \frac{{reproj\_error}^{2}}{max\_reproj {\_error}^{2}} = 1$$

Where max_pᵢ is the maximum value range of element pᵢ, and max_reproj_error is the maximum acceptable re-projection pixel error. The re-projection error reproj_error can be calculated based on the above formula, where the larger the value, the wider the range of plan expansion, and the greater the degree of point cloud integration. There are many options for the specific measurement of the different of the element pᵢ as long as it meets the reality. That is, the closer the elements are, the smaller the value of the different measurement function may be.

The following uses the element as the color (rgb) to illustrate the calculation method of the different measurement. The color difference between two depth images can be set as difference=²\sqrt{(r₁−r₂)²+(g₁−g₂)²+(b₁−b₂)²}, or it can be set as difference=|r₁−r₂|+|g₁−g₂|+|b₁−b₂|.

The above two color difference measurement methods between the depth images all satisfy the rule that the closer the colors are, the smaller the difference value may be. Therefore, for any measurable element, there can be multiple ways of measuring the difference, as long as it meets the rule where the closer or more similar the elements, the smaller the difference value may be.

The following is a detailed analysis of the above formula in conjunction with FIG. 9. FIG. 9 shows the above formula where n=1 and the element p is the angle of the normal vector of the point cloud in the area to be determined. FIG. 9 uses the vector angle to represent the difference between normal vectors. FIG. 9 intuitively shows that when the angle of the point cloud in the area to be determined is larger, the re-projection error value is smaller. Since the normal vector includes a large angle, it may indicate that the normal vector has a large variance, and that the normal vector may change greatly, indicating that the probability of the area being a plane may be low. Therefore the plane should not be expanded and fused.

For other elements, the analysis method is consistent with the above process. For example, when the element is determined to be color (texture) consistent, when the color of the point cloud in the area to be determined is more similar, the color variance may be smaller, indicating it may be more likely from the same geometrical similarity area. Therefore, the expansion of this area can be increased, that is, the larger the re-projection pixel error can be set. When the determination element is the curvature, when the curvature in the area to be determined is very small and close to zero, the area can be considered as a flat area, and the re-projection pixel error can be increased. It can be understood that the plane expansion fusion detection method described above is merely an exemplary description, and any suitable calculation method can be used to perform plane expansion fusion detection, which is not limited in the embodiments of the present disclosure.

D, if the conditions (I) to (IV) in the operation (C) described above are all satisfied, the candidate pixel corresponding to the 3D point can be pressed into the fusion queue, and the pixel can be set to the fused state. The operations (A) and (B) in the process at S4 can be performed on the candidate pixel.

E, repeating the operations (A), (B), (C), and (D) described above until the candidate queue is empty.

F, calculating the median values of the x, y, and z coordinates of all 3D points in the fusion queue and the median values of r, g, and b corresponding to the colors of all points, and setting these values as the 3D coordinates of the new fusion point and its corresponding colors.

S5, repeating the process at S4 until all pixels are fused.

S6, outputting the all newly generated fusion points and generating a fusion point cloud.

This technical solution comprehensively considers the depth error, the re-projection error, the vector angle, and the curvature information to perform depth image point cloud fusion for the entire scene. In addition, comparing the fused image obtained after the fusion process of the depth image by this method and the fused image obtained by the method in conventional technology, it can be seen that the number of point clouds of the fused image obtained by this method is greatly reduced. Further, the obtained point cloud data also fully displays the entire scene, the plane area uses fewer 3D points to represent, and the area with larger terrain uses more point clouds to display details, which maintains the display effect of each detail part in the depth image. Furthermore, in the fused image obtained by this method, the point cloud noise data is significantly reduced, which further ensures the efficiency of synthesizing point cloud data from the depth image and the display quality of the synthesized point cloud data, thereby improving the practicability of the depth image fusion method, which is beneficial to the promotion and application of the related products.

It can be understood that only one or more of the depth error, the re-projection error, the vector angle, and the curvature information can be considered to perform the depth image point cloud fusion for the entire scene, or other suitable methods can be used to perform the depth image point cloud fusion. Similarly, other suitable calculation methods can also be used to obtain the 3D coordinates of the new fusion point and its corresponding color. This embodiment is merely an exemplary description and is not a limitation of the present disclosure.

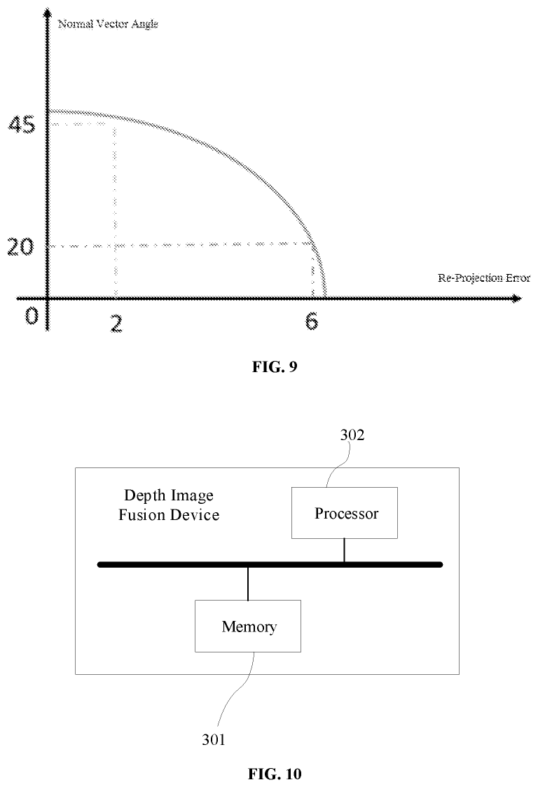

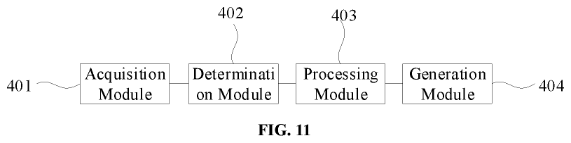

FIG. 10 is a schematic structural diagram of a depth image fusion device according to an embodiment of the present disclosure. Referring to FIG. 10, an embodiment of the present disclosure provides a depth image fusion device, which can be configured to perform the fusion method described above.

More specifically, the depth image fusion device includes a memory 301 configured to store program instructions and a processor 302 configured to execute the program instructions stored in the memory 301. When executed by the processor 302, the program instructions can cause the processor 302 to obtain at least one depth image and a reference pixel positioned in at least one of the depth images; determine a candidate queue corresponding to the reference pixel in the at least one of the depth images, the candidate queue storing at least one pixel to be fused in the depth image that has not been fused; determine a fusion queue corresponding to the reference pixel in the at least one of the depth images in the candidate queue, and press the pixels to be fused in the candidate queue into the fusion queue, the fusion queue storing at least one selected fusion pixels in the depth image; obtain the feature information of the selected fusion pixel in the fusion queue; determine the standard feature information of the fusion pixel based on the feature information of the selected fusion pixel; and generate a fused point cloud corresponding to at least one of the depth images based on the standard feature information of the fused pixels.

In some embodiments, when determining the candidate queue corresponding to the reference pixel in at least one of the depth images, the processor 302 may be further configured to determine a reference depth image and a reference pixel in the reference depth image in at least one depth image; obtain at least one adjacent depth image corresponding to the reference depth image; and determine the pixels to be fused to be pressed into the candidate queue and the candidate queue corresponding to the reference pixel based on the reference pixel and at least one adjacent depth image.

In some embodiments, when determining the pixels to be fused into the candidate queue based on the reference pixel and at least one adjacent depth image, the processor 302 may be configured to project the reference pixel to at least one adjacent depth image to obtain at least one first projection pixel; detect adjacent pixels in at least one adjacent depth image based on the at least one first projection pixel; and determine the first projection pixel and the adjacent pixels as the pixels to be fused and pressed into the candidate queue.

More specifically, when detecting the adjacent pixels in at least one adjacent depth image based on the at least one first projection pixel, the processor 302 may be configured to obtain the unfused pixels in at least adjacent depth image based on at least one first projection pixel; and determine adjacent pixels in at least one adjacent depth image based on the unfused pixels in at least one adjacent depth image.

In some embodiments, when determining the adjacent pixels in at least one adjacent depth image based on the unfused pixels in the at least one adjacent depth image, the processor 302 may be configured to obtain the traversal levels corresponding to the unfused pixels in the at least one adjacent depth image; and determine the unfused pixels whose traversal level is less than a predetermined traversal level as the adjacent pixels.

In some embodiments, after determining the first projection pixel and the adjacent pixels as pixels to be fused, and pressing these pixels into the candidate queue, the processor 302 may be further configured to add one to the traversal level of the pixels pressed into the candidate queue.

In addition, before obtaining at least one adjacent depth image corresponding to the reference depth image, the processor 302 may be further configured to obtain at least one common point cloud coverage range existing between the reference depth image and the other depth images; and determine one of the other depth images is a first adjacent candidate image of the reference depth image when the coverage range of the at least one common point cloud existing between the reference depth image and one of the other depth images is greater than or equal to a predetermined coverage range threshold.

In some embodiments, when obtaining at least one adjacent depth image corresponding to the reference depth image, the processor 302 may be configured to determine a first target adjacent candidate image in the first adjacent candidate image, the common point cloud coverage range between the first target adjacent candidate image and the reference depth image may be greater than or equal to the predetermined coverage range threshold; sort the first target adjacent candidate images based on the size of the common point cloud coverage range with the reference depth image; and determine at least one adjacent depth image corresponding to the reference depth image in the sorted first target adjacent candidate images based on a predetermined maximum number of adjacent images.

In addition, before obtaining at least one adjacent depth image corresponding to the reference depth image, the processor 302 may be configured to obtain a reference center coordinates corresponding to the reference depth image and at least one center coordinates corresponding to the other depth images; and determine a second adjacent candidate image corresponding to the reference depth image based on the reference center coordinates and at least one center coordinates in other depth images.

In some embodiments, when determining a second adjacent candidate image corresponding to the reference depth image based on the reference center coordinates and at least one center coordinates in other depth images, the processor 302 may be configured to obtain at least one 3D pixel, the 3D pixel may be positioned in the common point cloud coverage range between the reference depth image and a depth image in other depth images; determine a first ray based on the reference center coordinates and the 3D point; determine at least one second ray based on at least one center coordinate and the 3D point; obtain at least one angle formed between the first ray and at least one second ray; and determine the second adjacent candidate images corresponding to the reference depth image based on at least one angle.

In some embodiments, when obtaining at least one 3D point, the processor 302 may be configured to obtain the first camera attitude information in the world coordinate system corresponding to the reference depth image and the second camera attitude information in the world coordinate system corresponding to one of the other depth images; and determine at least one 3D pixel based on the first camera attitude information and the second camera attitude information in the world coordinate system.

In some embodiments, when determining the second adjacent candidate image corresponding to the reference depth image based on at least one angle, the processor 302 may be configured to obtain a target angle with the smallest angle in the at least one angle; and determine the depth image corresponding to the target angle as the second adjacent candidate image corresponding to the reference depth image when the target angle is greater than or equal to a predetermined angle threshold.

In some embodiments, when obtaining at least one adjacent depth image corresponding to the reference depth image, the processor 302 may be configured to determine a plurality of second target adjacent candidate images in the first adjacent candidate images and the second adjacent candidate images, the common point cloud coverage range between the second target adjacent candidate images and the reference depth image may be greater than or equal to the predetermined coverage range threshold, and the target angle corresponding to the second target adjacent candidate images may be greater than or equal to the predetermined angle threshold; sort the second target adjacent candidate images based on the size of the common point cloud coverage range with the reference depth image; and determine at least one adjacent depth image corresponding to the reference depth image in the sorted second target adjacent candidate images based on a predetermined maximum number of adjacent images.

In some embodiments, the processor 302 may be further configured to detect whether all the pixels to be fused in the candidate queue have been pressed into the fusion queue; detect whether the pixels to be fused in the candidate queue meet a predetermined fusion condition when not all the pixels to be fused in the candidate queue are pressed into the fusion queue; press the pixels to be fused into the fusion queue when the pixels to be fused meet the fusion condition; and iteratively detect whether other reference pixels in at least one depth image meet the fusion condition after the pixels to be fused in the candidate queue of the reference pixel have all been pressed into the fusion queue.

In some embodiments, before detecting whether the pixels to be fused in the candidate queue meet the predetermined fusion condition, the processor 302 may be further configured to obtain the depth value error between the pixels to be fused and the reference pixel in the reference depth image; obtain the angle between the normal vector of the pixel to be fused and the reference pixel in the reference depth image; obtain the re-projection error between a second projection pixel of the pixel to be fused and the reference pixel in the reference depth image; and obtain the traversal level of the pixels to be fused.

In some embodiments, before obtaining the re-projection error between a second projection pixel of the pixel to be fused and the reference pixel in the reference depth image, the processor 302 may be further configured to project the pixel to be fused onto the reference depth image to obtain the second projection pixel corresponding to the pixel to be fused.

In some embodiments, after obtaining the re-projection error between a second projection pixel of the pixel to be fused and the reference pixel in the reference depth image, the processor 302 may be further configured to obtain the element difference information between all pixels to be fused in the candidate queue; and determine the maximum re-projection error between the second projection pixel and the reference pixel based on the element difference information.

In some embodiments, the element difference information may include the difference information of the vector angle. When determining the maximum re-projection error between the second projection pixel and the reference pixel based on the element difference information, the processor 302 may be configured to calculate the vector angle between all pixels to be fused in the candidate queue; determine a maximum vector angle in all vector angles; determine the maximum re-projection error as a predetermined first maximum re-projection error when the maximum vector angle is less than or equal to a predetermined maximum vector angle threshold; or, determine the maximum re-projection error as a predetermined second maximum re-projection error when the maximum vector angle is greater than the predetermined maximum vector angle threshold, where the second maximum re-projection error may be less than the first maximum re-projection error.

In some embodiments, when detecting whether the pixels to be fused in the candidate queue meet the predetermined fusion condition, the processor 302 may be configured to determine whether the depth value error is less than or equal to the predetermined maximum depth threshold, whether the normal vector angle is less than or equal to the predetermined maximum angle threshold, whether the re-projection error is less than or equal to the maximum re-projection error, and whether the traversal level is less than or equal to the predetermined maximum traversal level; and determine the pixels to be fused in the candidate queue meet the predetermined fusion condition when the depth value error is less than or equal to the predetermined maximum depth threshold, when the normal vector angle is less than or equal to the predetermined maximum angle threshold, when the re-projection error is less than or equal to the maximum re-projection error, and when the traversal level is less than or equal to the predetermined maximum traversal level.

In some embodiments, the feature information may include the coordinate information and the color information. When determining the standard feature information of the fused pixel based on the feature information of all selected fusion pixels, the processor 302 may be configured to determine the median value in the coordinate information of all fused pixels as the standard coordinate information of the fused pixels; and determine the median value in the color information of all fused pixels as the standard color information of the fused pixels.

In some embodiments, before determining the candidate queue and the fusion queue corresponding to the at least one depth image, the processor 302 may be further configured to clear the candidate queue and the fusion queue; and mark all pixels as unfused pixels, and set the traversal level of all pixels to zero.

The specific implementation principle and implementation effect of the depth image fusion device provided in this embodiment are consistent with the depth image fusion method corresponding to FIG. 1 to FIG. 9. For details, reference may be made to the previous description, which will not be repeated here.

FIG. 11 is a schematic structural diagram of another depth image fusion device according to an embodiment of the present disclosure. As shown in FIG. 11, an embodiment of the present disclosure provides another depth image fusion device, which can also perform the fusion method described above.

More specifically, the depth image fusion device includes an acquisition module 401 configured to obtained at least one depth image, and a determination module 402 configured to determine a candidate queue and a fusion queue corresponding to at least one depth image. The candidate queue can store at least one unfused pixel in the depth image to be fused, and the fusion queue can store at least one selected fusion pixel in the depth image.

In some embodiments, the acquisition module 401 can be further configured to obtain the feature information of all selected fusion pixels in the fusion queue when all the pixels to be fused in the candidate queue are pressed into the fusion queue.

The depth image fusion device further includes a processing module 403 configured to determine the standard feature information of the fused pixel based on the feature information of all the selected fusion pixels, and a generation module 404 configured to generate a fused point cloud corresponding to at least one depth image based on the standard feature information of the fused pixels.

The acquisition module 401, the determination module 402, the processing module 403, and the generation module 404 in the depth image fusion device provided in this embodiment may correspond with the depth image fusion method corresponding to FIG. 1 to FIG. 9. For details, reference may be made to the previous description, which will not be repeated here.

An embodiment of the present disclosure further provides a computer-readable storage medium. The computer readable storage medium stores program instructions, and the program instructions can be used to implement the aforementioned depth image fusion method.

The technical solutions and technical features in the foregoing various embodiments of the present disclosure may be separate or combined when there is no confliction. Equivalent embodiments are within the scope of the present disclosure as long as they do not exceed the knowledge scope of those skilled in the art.

In the several embodiments provided by the present disclosure, it should be understood that the disclosed system, apparatus, and method may be implemented in other manners. For example, the device embodiments described above are merely illustrative. For example, the division of the units is only a logical function division. In actual implementation, there may be another division manner, for example, multiple units or components may be combined or integrated into another system. Some features can be omitted or not executed. In addition, the coupling or direct coupling or communication connection shown or discussed may be an indirect coupling or communication connection through some interface, device or unit, and may be electrical, mechanical or otherwise.

The units described as separate components may or may not be physically separated, and the components displayed as units may or may not be physical units, that is. They may be located in one location or may be distributed to multiple network units. Some or all of the units may be selected according to actual needs to achieve the purpose of the solution of the embodiment.

Further, each functional unit in each embodiment of the present disclosure may be integrated into one processing unit, or each unit may exist physically separately, or two or more units may be integrated into one unit. The above integrated unit may be implemented in the form of hardware or in the form of a software functional unit.

The integrated unit, if implemented in the form of a software functional unit and sold or used as a standalone product, may be stored in a computer readable storage medium. Based on such understanding, the technical solution of the present disclosure, or all or part of the technical solution, may be embodied in the form of a software product stored in a storage medium, including several instructions for instructing a computer processor to perform all or part of the steps of the methods of the various embodiments of the present disclosure. The storage medium may include: a U disk, a mobile hard disk, a read-only memory (ROM), a random-access memory (RAM), a magnetic disk, or an optical medium that can store program codes.

The foregoing embodiments are not intended to limit the scope of the present disclosure. Equivalent structures or equivalent process transformations made based on the description and drawings of the present disclosure directly or indirectly applied to other related technologies are all included in the scope of the present disclosure.

It should be noted that the above embodiments are merely illustrative of the technical solutions of the present disclosure, and are not intended to be limiting. Although the present disclosure has been described in detail with reference to the foregoing embodiments, those skilled in the art will understand that the technical solutions described in the foregoing embodiments may be modified, or some or all of the technical features may be equivalently replaced; and the modifications or substitutions do not deviate from the scope of technical solutions of the present disclosure.

What is claimed is:

1. A depth image fusion method, comprising:
obtaining at least one depth image and a reference pixel positioned in at least one of the depth images;
determining a candidate queue corresponding to the reference pixel in at least one of the depth images, the candidate queue storing at least one pixel to be fused that has not been fused in the depth image;
determining a fusion queue corresponding to the reference pixel in the at least one of the depth images in the candidate queue, and pressing pixel to be fused in the candidate queue to the fusion queue, the fusion queue storing at least one selected fusion pixel in the depth image;
obtaining feature information of the selected fusion pixel in the fusion queue;
determining standard feature information of the fused pixel based on the feature information of the selected fusion pixel; and
generating a fused point cloud corresponding to at least one of the depth images based on the standard feature information of the fused pixel.

2. The method of claim 1, wherein determining the candidate queue corresponding to the reference pixel in at least one of the depth images includes:
determining a reference depth image and the reference pixel positioned in the reference depth image in at least one of the depth images;
obtaining at least one adjacent depth image corresponding to the reference depth image; and
determining the pixel to be fused and the candidate queue corresponding to the reference pixel to be pressed into the candidate queue based on the reference pixel and at least one of the adjacent depth images.

3. The method of claim 2, wherein determining the pixel to be fused for pressing into the candidate queue based on the reference pixel and at least one of the adjacent depth images includes:
projecting the reference pixel onto at least one of the adjacent depth images to obtain at least one first projection pixel;
detecting at least one adjacent pixel in the adjacent depth image based on at least one of the first projection pixels; and
determining the first projection pixel and the adjacent pixel as the pixels to be fused, and pressing the pixels to be fused into the candidate queue.

4. The method of claim 3, wherein detecting at least one adjacent pixel in the adjacent depth image based on the at least one first projection pixel includes:
obtaining at least one unfused pixel in the adjacent depth image based on at least one of the first projection pixels; and
determining at least one adjacent pixel in the adjacent depth image based on at least one unfused pixel in the adjacent depth image.

5. The method of claim 4, wherein determining at least one adjacent pixel in the adjacent depth image based on at least one unfused pixel in the adjacent depth image includes:
obtaining a traversal level corresponding to at least one unfused pixel in the adjacent depth image; and
determining the unfused pixels whose traversal level is less than a predetermined traversal level as the adjacent pixels.

6. The method of claim 3, wherein after determining the first projection pixel and the adjacent pixel as the pixels to be fused, and pressing the pixels to be fused into the candidate queue, further comprising:
adding one to the traversal level of the pixels pressed into the candidate queue.

7. The method of claim 2, wherein before obtaining at least one adjacent depth image corresponding to the reference depth image, further comprising:
obtaining at least one common point cloud coverage range between the reference depth image and other depth images; and
determining one of the other depth images is a first adjacent candidate image of the reference depth image when at least one common point cloud coverage range exists between the reference depth image and one of the other depth images is greater than or equal to a predetermined coverage range threshold.

8. The method of claim 7, wherein obtaining at least one adjacent depth image corresponding to the reference depth image includes:
determining a first target adjacent candidate image in the first adjacent candidate image, the common point cloud coverage range between the first target adjacent candidate image and the reference depth image is greater than or equal to the predetermined coverage range threshold;
sorting the first target adjacent candidate image based on a size of the common point cloud coverage range with the reference depth image; and
determining at least one adjacent depth image corresponding to the reference depth image in the sorted first target adjacent candidate image based on a predetermined maximum number of adjacent images.

9. The method of claim 7, wherein before obtaining at least one adjacent depth image corresponding to the reference depth image, further comprising:
obtaining a reference center coordinates corresponding to the reference depth image and at least one center coordinates corresponding to the other depth images; and
determining a second adjacent candidate image corresponding to the reference depth image based on the reference center coordinates and at least one center coordinates in the other depth images.

10. The method of claim 9, wherein determining the second adjacent candidate image corresponding to the reference depth image based on the reference center coordinates and at least one center coordinates in the other depth images includes:
obtaining at least one 3D pixel, the 3D pixel being positioned within the common point cloud coverage range existing between the reference depth image and one of the other depth images;
determining a first ray based on the reference center coordinates and the 3D pixel;
determining at least one second ray based on at least one of the center coordinates and the 3D pixel;
obtaining at least one angle formed between the first ray and at least one of the second rays; and
determining a second adjacent candidate image corresponding to the reference depth image based on at least one of the angles.

11. The method of claim 10, wherein obtaining at least one 3D pixel includes:
obtaining first camera attitude information in a world coordinate system corresponding to the reference depth image and second camera attitude information in the world coordinate system corresponding to one of the other depth images;
determining at least one of the 3D points based on the first camera attitude information and the second camera attitude information in the world coordinate system.

12. The method of claim 10, wherein determining the second adjacent candidate image corresponding to the reference depth image based on at least one of the angles includes:
obtaining a target angle within a smallest angle in at least one of the angles; and
determining the depth image corresponding to the target angle is the second adjacent candidate image corresponding to the reference depth image when the target angle is greater than or equal to a predetermined angle threshold.

13. The method of claim 9, wherein obtaining at least one adjacent depth image corresponding to the reference depth image includes:
determining a second target adjacent candidate image in the first adjacent candidate image and the second adjacent candidate image, the common point cloud coverage range between the second target adjacent candidate image and the reference depth image being greater than or equal to the predetermined coverage range threshold, and the target angle corresponding to the second target adjacent candidate being greater than or equal to the predetermined angle threshold;
sorting the second target adjacent candidate image based on the size of the common point cloud coverage range with the reference depth image; and
determining at least one adjacent depth image corresponding to the reference depth image in the sorted second target adjacent candidate image based on the predetermined maximum number of adjacent images.

14. The method of claim 2 further comprising:
detecting whether the pixels to be fused in the candidate queue have all been pressed into the fusion queue;
detecting whether the pixels to be fused in the candidate queue meet a predetermined fusion condition when the pixels to be fused in the candidate queue are not all pressed into the fusion queue;
pressing the pixels to be fused into the fusion queue when the pixels to be fused meet the predetermined fusion condition; and
iteratively detecting whether other reference pixels in at least one depth image meet the predetermined fusion condition after the pixels to be fused in the candidate queue of the reference pixel have all been pressed into the fusion queue.

15. The method of claim 14, wherein before detecting whether the pixels to be fused in the candidate queue meet the predetermined fusion condition, further comprising:
obtaining a depth value error between the pixels to be fused and the reference pixel in the reference depth image; and/or
obtaining an angle between a normal vector of the pixels to be fused and the reference pixel in the reference depth image; and/or
obtaining a re-projection error between a second projection pixel of the pixels to be fused and the reference pixel in the reference depth image; and/or
obtaining the traversal level of the pixels to be fused.

16. The method of claim 15, wherein before obtaining the re-projection error between the second projection pixel of the pixels to be fused and the reference pixel in the reference depth image, further comprising:
projecting the pixels to be fused onto the reference depth image to obtain the second projection pixel corresponding to the pixels to be fused.

17. The method of claim 15, wherein after obtaining the re-projection error between the second projection pixel of the pixels to be fused and the reference pixel in the reference depth image, further comprising:
obtaining element difference information between all pixels to be fused in the candidate queue; and
determining a maximum re-projection error between the second projection pixel and the reference pixel based on the element difference information.

18. The method of claim 17, wherein:
the element difference information includes vector angle difference information; and
determining the maximum re-projection error between the second projection pixel and the reference pixel based on the element difference information includes:
calculating the vector angles between all pixels to be fused in the candidate queue;
determining a maximum vector angle in all vector angles;
determining the maximum re-projection error being a predetermined first maximum re-projection error when the maximum vector angle is less than or equal to a predetermined maximum vector angle threshold; or
determining the maximum re-projection error being a predetermined second maximum re-projection error when the maximum vector angle is greater than the predetermined maximum vector angle threshold, the second predetermined second maximum re-projection error being smaller than the first predetermined second maximum re-projection error.

19. The method of claim 15, wherein detecting whether the pixels to be fused in the candidate queue meet the predetermined fusion condition includes:
detecting whether the depth value error is less than or equal to a predetermined maximum depth threshold, whether the normal vector angle is less than or equal to the predetermined maximum angle threshold, whether the re-projection error is less than or equal to a maximum re-projection error, and whether the traversal level is less than or equal to a predetermined maximum traversal level; and
determining the pixels to be fused in the candidate queue meeting the predetermined fusion condition when the depth value error is less than or equal to the predetermined maximum depth threshold, when the normal vector angle is less than or equal to the predetermined maximum angle threshold, when the re-projection error is less than or equal to the maximum re-projection error, and when the traversal level is less than or equal to the predetermined maximum traversal level.

20. The method of claim 1, wherein:
the feature information includes coordinate information and color information; and
determining the standard feature information of the fused pixel based on the feature information of all selected fusion pixels includes:
determining a median value in the coordinate information of all fusion points as standard coordinate information of the fused pixel; and
determining a median value in the color information of all fusion points as standard color information of the fused pixel.
